(19) United States
(12) Patent Application Publication
(10) Pub. No.: US 2009/0014242 A1
(43) Pub. Date: Jan. 15, 2009

(54) Wirelessly controlled fire escape devices

(76) Inventor: Haishan Tang, Zhongshan (CN)

Correspondence Address: LATHROP & GAGE LC, 4845 PEARL EAST CIRCLE, SUITE 300, BOULDER, CO, 80301, US

(21) Appl. No.: 12/099,325

(22) Filed: Apr. 8, 2008

(30) Foreign Application Priority Data
Jul. 12, 2007 (CN) 200710075883.2

(51) Int. Cl. A62B 1/08; B66B 9/00; B66B 1/06

(52) U.S. Cl. 182/241; 187/239; 187/306

(57) ABSTRACT

Disclosed is a fire escape device which can be controlled wirelessly. The device comprises a rope winding unit having a rope, a carrying unit fixed to one end of the rope, a main control unit fixed onto a building, through which the rope is connected to the man-carrying unit so as to control a descent process of the carrying unit, and at least one wireless remote control capable of communicating with the main control unit and operating the same.

### RELATED APPLICATIONS

This application claims the benefit of Chinese application No. 200710075883.2 filed on Jul. 12, 2007 which is explicitly incorporated by reference in its entirety.

### FIELD OF THE INVENTION

The present invention relates to a self-help device in the event of fire and, more particularly, to a fire escape device for high-rise buildings, which can be controlled wirelessly.

### BACKGROUND OF THE INVENTION

Life-saving escape apparatus currently used in top floors of a high-rise generally includes two types of devices. One type of device is aerial ladders which are primarily used by firefighters and for delivery of firefighting equipments. However these ladders are too large and therefore they are not easy to reach fire sites.

The other kind of escape apparatus of life-saving is slow-lowering devices which also have many defects. Firstly, its lowering speed can be only set fixedly and cannot be regulated during a lowering process. So it is not safe enough for an escapee because the escapee may be hurt due to impacting barriers on walls of buildings such as air-conditioner, electrical wire, the advertising lamp box etc. during the lowering process; even if the escapee has noted the barriers, he cannot decelerate himself or change the lowering path and thus an impact may be unavoidable. Secondly, the devices in the art normally provide no communication tools, so that the real time communication cannot be realized between the escapee and the succor-escorting people or the receiving people on the ground.

### SUMMARY OF THE INVENTION

A wirelessly controllable fire escape device is provided according to the present invention, which comprises: a rope winding unit having a connecting means, such as a rope; a carrying unit fixed to one end of the rope; a main control unit fixed onto a building, through which the rope is connected to the man-carrying unit so as to control a lowering process of the carrying unit; and at least one wireless remote control capable of communicating with the main control unit and operating the same.

### BRIEF DESCRIPTION OF THE DRAWINGS

Other objects, features and advantages of the present invention will become more apparent from the following detailed description when read in conjunction with the accompanying drawing, in which:

FIG. 1 is a schematic view of the whole structure of a fire escape device according to the present invention;

FIG. 2A is a schematic perspective view of the main control unit (without the housing for clarity) of the fire escape device shown in FIG. 1;

FIG. 2B is a cutaway view of the main control unit shown in FIG. 2A;

FIG. 2C is a schematic view of a measurement means of lowering-distance disposed in the main control unit shown in FIG. 2A;

FIG. 2D is a schematic view of the speed-limiting means disposed in the main control unit shown in FIG. 2A;

FIG. 2E is a schematic perspective view of the brake of magnetic powder disposed in the main control unit shown in FIG. 2A;

FIG. 2F is a schematic view of the manual brake disposed in the main control unit shown in FIG. 2A;

FIG. 2G is a schematic view of the housing of the main control unit shown in FIG. 2A;

FIG. 2H is a block diagram of the main controller of the main control unit shown in FIG. 2A;

FIG. 3A is a front view of the remote control shown in FIG. 1;

FIG. 3B is a block diagram of the circuit of the remote control shown in FIG. 3A;

FIG. 4 is a schematic view of the baby or child bag of anti-collision of the man-carrying unit shown in FIG. 1;

FIG. 5A is a perspective view of the rope winding unit shown in FIG. 1;

FIG. 5B is a plan view of the crank for rolling the rope winding unit shown in FIG. 5A;

FIG. 5C is a section view of the axle of the rope winding unit shown in FIG. 5A;

FIG. 6A is a front view of the positioning device in air of the present invention;

FIG. 6B is a top view of the positioning device in air shown in FIG. 6A;

FIG. 6C is a block diagram of the controller of the positioning device shown in FIG. 6A;

FIG. 7A is a perspective view of a cantilever means for fixing the main control unit according to the present invention;

FIG. 7B is an exploded view of the cantilever means shown in FIG. 7A;

FIG. 7C is a perspective view of a bracket unit for fixing the main control unit according to the present invention;

FIG. 8 is a schematic view illustrating the state of lowering of an escapee using the fire escape device according to the present invention.

### DETAILED DESCRIPTION OF THE PREFERRED EMBODIMENTS

Hereinafter, preferred embodiments of the present invention will be described in details with reference to the accompanying drawings.

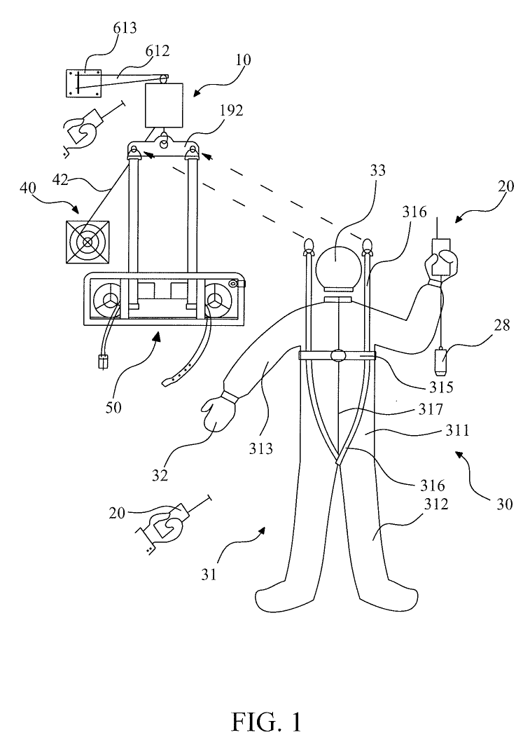

Referring to FIG. 1, the high speed fire escape device which can be controlled wirelessly according to the present invention comprises a rope winding unit 40 having a rope 42 which can be drawn in and drawn out; a man-carrying unit (or carrying unit) 30 for carrying a subject like a person in fire fixed to one end of the rope 42, so as to lower the person as the rope 42 draws out; a main control unit 10 by which the rope 42 is connected to the man-carrying unit 30, so as to control the lowering process of the man-carrying unit 30 by means of the main control unit 10; and at least one wireless remote control 20 capable of communicating with the main control unit 10, so as to operate the main control unit 10 by the remote control 20.

Usually, the rope winding unit 40 and the main control unit 10 are fixed onto a wall of a building especially on a place near a fleeing window or in a shelter room by conventional means in prior art or by those provided by the present invention (as described below). Therefore people who live in a high story can ride on and lower together with the man-carrying unit 30 to the ground as the rope 42 drawing out under the control of the main control unit 10 upon the operation of the remote control 20.

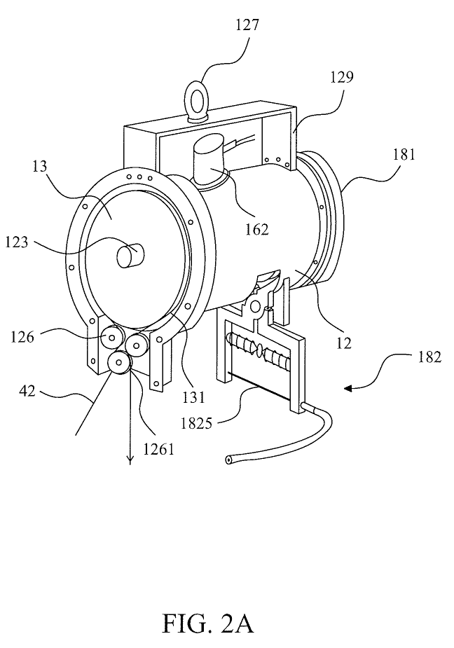

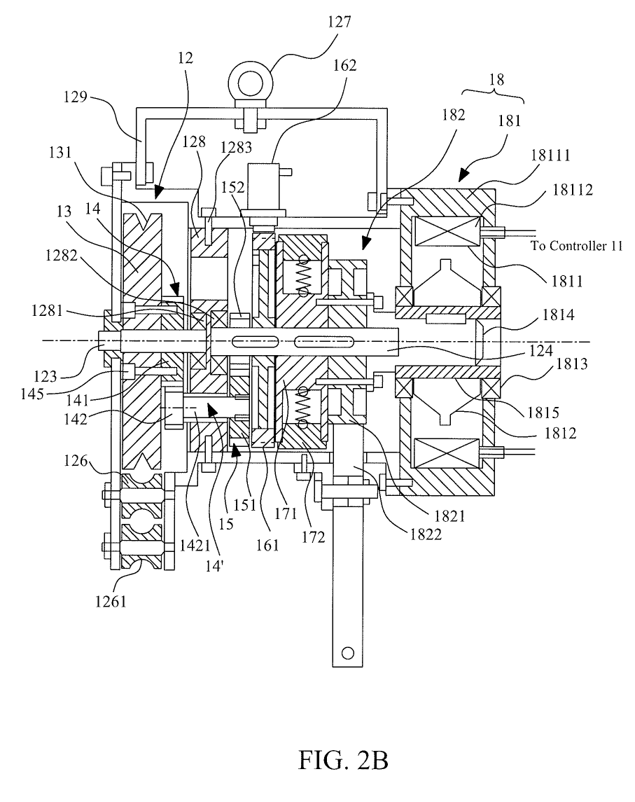

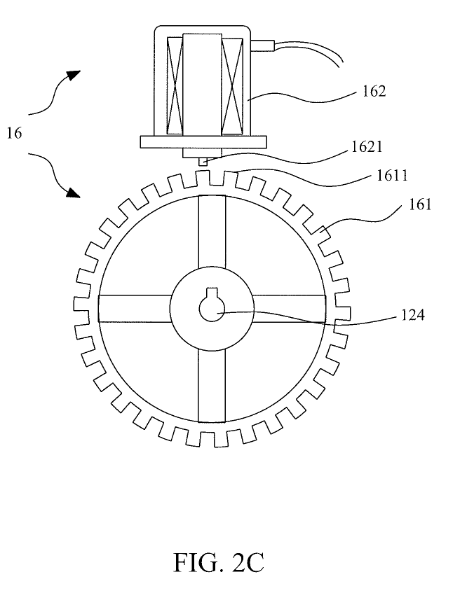

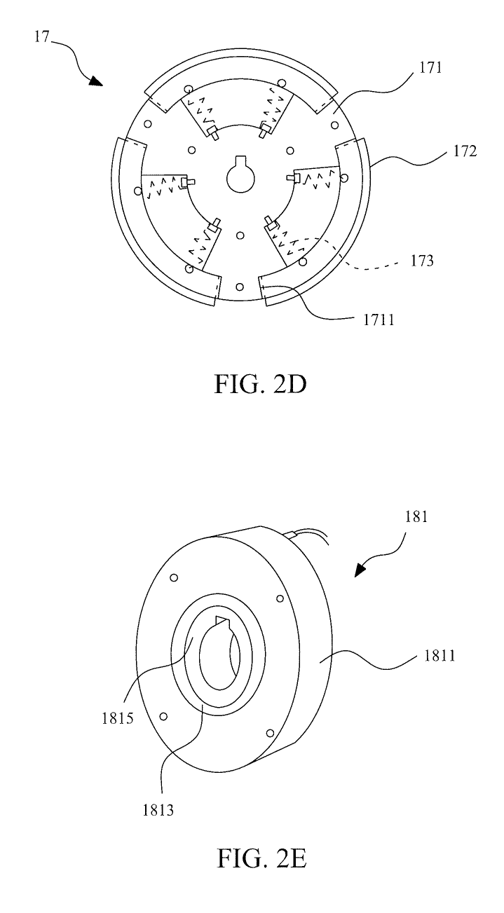

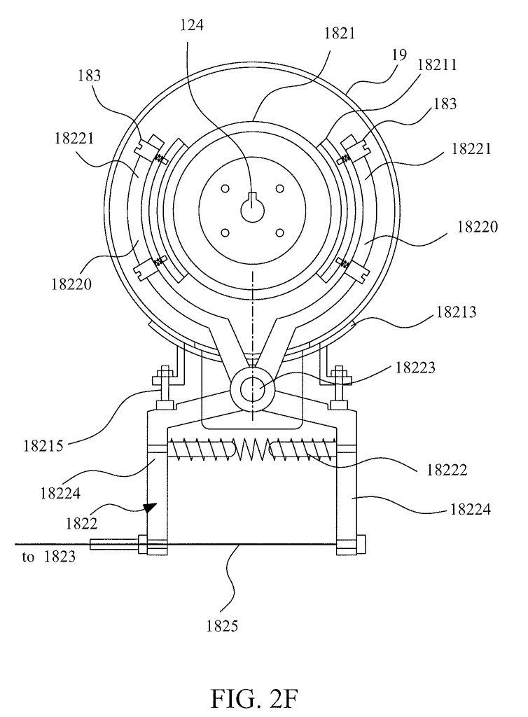

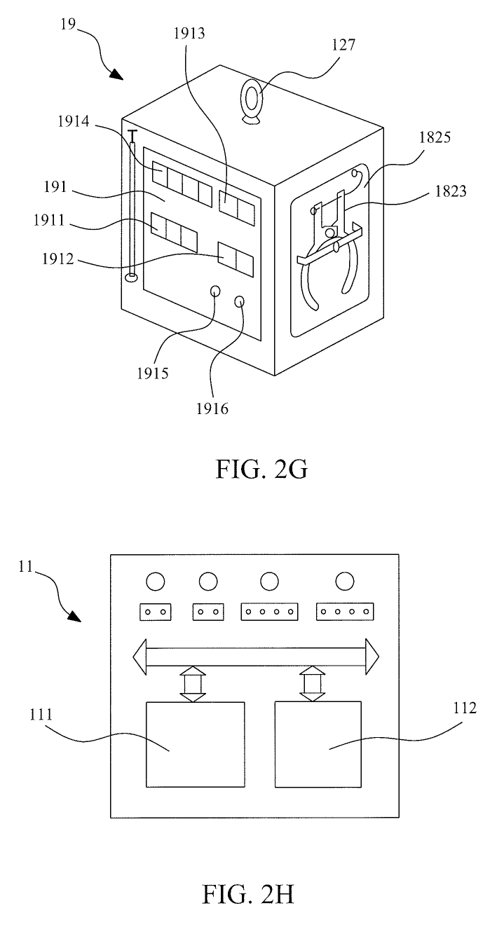

The main control unit 10 is one of the important mechanisms of the fire escape device according to the present invention, of which the structure is shown in FIG. 2A through 2H.

The main control unit 10 comprises a housing 19 (see FIG. 2G) for fixing to a building; a main controller 11 (see FIG. 2H) for communicating with the remote controls 20, which is disposed in the housing 19 and electrically connected to a main control panel 191; and a cartridge 12 disposed in the housing 19 (see FIG. 2A and 2B), being a hollow cylinder and inside which a pulley 13 for drawing in or drawing out the rope 42 and a mechanism for controlling rotation of the pulley 13 are provided. A bracket 129 on which a suspension ring 127 for hanging the main control unit 10 is provided is disposed on the top of the cartridge 12.

Referring to FIG. 2A which illustrates the appearance of the cartridge 12, a plurality of guide pulleys 126 for guiding the rope 42 are disposed at the left end of the cartridge 12 and beneath the pulley 13. As shown in FIG. 2A, three guide pulleys 126 are provided in this embodiment, and all the pulleys 126 are disposed at the same plane as the pulley 13 and arranged at the positions of a triangle. The pulley 13 and the guide pulley 126 are of solid structures and a coattail groove 131 is formed on the periphery of the former, while a groove 1261 in an arc shape is formed on the periphery of the latter. One end of the rope 42 passes through the groove 1261 and the coattail groove 131, and is connected to the man-carrying unit 30. The rope 42 received within grooves 131, 1261 is drawn in or drawn out as the pulley 13 and the guide pulley 126 rotate. Preferably, the surface of both the groove 131 and 1261 is formed with a plurality of small protrusions (not shown) for increasing the frictional force between the rope 42 and both the groove 131 and 1261, so as to prevent the rope 42 from skidding within the grooves 131 and 1261.

Referring to FIG. 2B which illustrates the inner structure of the cartridge 12, a first shaft 123 onto which the pulley 13 is provided and a second shaft 124 onto which a measurement mechanism 16 (see FIG. 2C) configured to measure a lowering-distance, a speed-limiting mechanism 17 (see FIG. 2D) and a brake unit 18 are provided, are axially in sequence disposed within the cartridge 12, and the first shaft 123 and the second shaft 124 are connected by means of a speed-increasing gear train 14′.

Still referring to FIG. 2B, more specifically, the speed-increasing gear train 14′ comprises a first gear group 14 including a first big gear 141 and a first small gear 142 engaged to the first big gear 141 and a second gear group 15 including a second big gear 151 and a second small gear 152 engaged to the second big gear 151.

The first big gear 141 is a driving gear disposed onto the first shaft 123 and fixed to the inside of the pulley 13 by means of bolts 145. Thus the first big gear 141 can be driven to rotate by the pulley 13.

The first small gear 142 is mounted onto one end of a third shaft 1421 which is rotatably disposed on a vertical connecting-plate 128, while the second big gear 151 is mounted onto the other end of the third shaft 1421. Therefore the second big gear 151 can coaxially rotate with the first small gear 142.

The vertical connecting-plate 128 is connected to the first shaft 123 and the second shaft 124 by means of bearings 1281, 1282 respectively, and is fixed to the cartridge 12 by means of bolts 1283. The vertical connecting-plate 128 is therefore stationary with respect of the cartridge 12.

The second small gear 152 is mounted onto the second shaft 124. In a preferred embodiment, either of the transmission ratios of the first gear group 14 and the second gear group 15 is 2:1, and as a result, they constitute a two step speed-increasing mechanism of which the total speed-increasing ratio is 4:1. In other words, the second shaft 124 will rotate for four circles while the first shaft 123 rotates for one circle during a process of the pulley 13.

Referring to FIG. 2B and FIG. 2C, the measurement means 16 according to one embodiment of the present invention comprises an electromagnetic impulse plate 161 mounted onto the second shaft 124 and an electromagnetic sensor 162. The electromagnetic impulse plate 161 is made of materials having high magnetic conductivity, having a plurality of teeth 1611 distributed along its periphery, and the electromagnetic sensor 162 has an iron core 1621 facing to the electromagnetic impulse plate 161.

The measurement means 16 operates as follows.
As the electromagnetic impulse plate 161 rotates, the iron core 1621 senses the teeth 1611 and gaps therebetween, and an AC (alternating current) will be generated in the electromagnetic sensor 162. An AC electromotive force of a cycle will be generated in the electromagnetic sensor 162 when the electromagnetic impulse plate 161 rotates for an angle of a tooth and a gap. When the electromagnetic impulse plate 161 continuously rotates upon rotation of the pulley 13, a signal of AC voltage of a certain frequency is generated in the electromagnetic sensor 162. The signal is then input into a Single-Chip Microcomputer (as described below) of the main controller 11 as inputting parameters of the lowing-speed and the length of the rope.

In a preferred embodiment according to the present invention, there are 48 teeth 1611 on the periphery of the electromagnetic impulse plate 161 and the perimeter of the pulley 13 is 0.4 m. It means that if the first shaft 123 and the pulley 13 rotated one circle per second, the lowering-speed of the rope 42 will be 0.4 m/s. As describe aforementioned, the second shaft 124 will rotate four circles when the pulley 13 rotates for one. Accordingly, the electromagnetic impulse plate 161 will rotate for 192 teeth during the period that the rope 42 lowers 0.4 m. As such, the length of rotating one tooth of the electromagnetic impulse plate 161 corresponding to the rope 42 is 0.0020833 m. Then the Single-Chip Microcomputer can calculate the lowering-distance of the rope 42 according to the signal transmitted by the electromagnetic sensor 162.

According to the present invention, the speed-limiting means 17 is provided for limiting the lowering-speed of the rope 42 to secure the escapee during the operation of the device.

Referring to FIG. 2B and 2D, the speed-limiting means 17 according to one embodiment of the invention comprises a centrifugal speed-limiting plate 171 in a disc-like shape mounted onto the second shaft 124, having a plurality of recesses 1711 at the periphery thereof in interval; and a plurality of centrifugal blocks 172 slidably disposed within the recesses 1711 respectively and elastically connected to the centrifugal speed-limiting plate 171.

In a preferred embodiment, each centrifugal block 172 is connected to the centrifugal speed-limiting plate 171 by two springs 173 fixed onto the plate 171 and a gap is formed between the inner surface of the cartridge 12 and the centrifugal block 172 when the spring 173 is free. However, the size of the gap will change when the rope 42 is lowered with different speeds because when the pulley 13 rotates, both the plate 171 and the centrifugal blocks 172 will also rotate together with the second shaft 124 and a centrifugal force of centrifugal blocks 172 thus generated is in proportion to the speed thereof in this period.

Therefore when the speed of the blocks 172 reaches a predetermined value, the centrifugal force thereof will overcome the spring force of the spring 173 and make the blocks 172 press the inner surface of the cartridge 12, thus a friction force is generated therebetween. The friction force is transmitted to the second shaft 124 and decelerated it, and then through the speed-increasing gear train 14′, makes the first shaft 123 and the pulley 13 decelerated, too. Accordingly, the lowering-speed of the rope 42 will decrease. In this case, the lowering-speed of the rope 42 will not surpass a predetermined value, which ensures the safe of escapees.

As shown in FIG. 2B, the brake unit 18 comprising a magnetic powder brake 181 and a manual brake 182 is provided for decelerating or making the rope 42 stop lowering.

Referring to FIG. 2B and FIG. 2E, the magnetic powder brake 181 according to one embodiment of the present invention comprises a stator 1811 consisted of a casing 18111 disposed within the cartridge 12 and a coil 18112 disposed within the casing 18111 and electrically connected to the main controller 11, and a rotator 1812 disposed within the casing 18111 and mounted onto a hollow shaft 1815 connected to the second shaft 124 via a coupling 1814. The two ends of the coil 18112 are connected to two connecting terminals respectively which are inserted into a PWM output socket of the main controller 11. The rotator 1812 is mounted onto the hollow shaft 1815 by two ball bearings 1813. The casing 18111 of the stator 1811 is fixed to the cartridge 12.

The manual brake 182 is provided for decelerating and braking the rope 42 when an emergency is occurred. Referring to FIG. 2B and 2F, the manual brake 182 according to one embodiment of the present invention comprises a braking plate 1821 mounted onto the second shaft 124; and a braking clamp 1822 consisting of two clamp levers 18220 which are hinged together at about the center thereof. The two clamp levers 18220 are divided into two portions by a hinge pivot 18223, one portion surrounding the braking plate 1821 and forming a pair of braking arms 18221, and the other portion extending downwards and forming a pair of handles 18224. A compression spring 18222 is disposed between the handles 18224. A brake rope 1825 connecting the free ends of the handles 18224; and a braking gripe 1823 connected to the brake rope 1825 for hauling the brake rope 1825 is also provided in the embodiment.

Referring to FIG. 2F, two brake shoes 18211 for contacting the braking plate 1821 are mounted onto the inside of the clamp levers 18221 by adjustable screws 183. Each adjustable screw 183 can consist of a screw and a compression spring housing on the screw.

Usually the brake shoes 18211 are made of rubber so as to improve the friction force between the brake shoes 18211 and the braking plate 1821 and to reduce wearing of the braking plate 1821. The distance between the braking arm 18221 and the brake shoe 18211 can be adjusted by the adjustable screws 183. Accordingly, the distance and the frictional force between the brake shoe 18211 and the braking plate 1821 can be adjusted. Generally the appropriate distance between them is 2 mm.

In another embodiment of the present invention, the closure degree of the two braking arms 18221 can be adjusted by adjusting quarter screws 18215 of which one end is connected to the handles 18224, while the other end is connected to a bracket 18213 fixed on the cartridge 12.

Usually, the braking gripe 1823 is hung on the outside of the housing 19 (referring to FIG. 2G). And when an emergency occurs, a succor (i.e. a fireman) will pick up and control the gripe 1823. For example when the lowering-speed of an escapee is too fast to safe, the succor can pinch the gripe 1823, thus making the brake rope 1825 tension, and the brake shoes 18211 hereby enclasp the braking plate 1821 to decelerate or stop the rotation of the second shaft 124 and the first shaft 123 in a moment.

As shown in FIG. 2G, the main controller 11 of the main control unit 10 according to an embodiment of the invention is configured on an IC located inside the housing 19.

Also referring to FIG. 2H, the main controller 11 comprises a control module 111 which is a Single-Chip Microcomputer in this embodiment, and a wireless remote control communication module 112 which is a radio communication IC chip, both of which are commercially available. Both the control module 111 and the wireless remote control communication module 112 can perform their function by software programmed therein, and are electrically connected to the main control panel 191 on which a XX height button 1911, an input button 1912 of the distance between an escapee and a wall, a speed indicator 1913, a XX height indicator 1914, a line indicator 1915 and an indicator light 1916 of the remote controller are provided (referring to FIG. 2G).

According to the present invention, the height of a story in which escapees live can be measured in advance, and the distance between the escapees and the wall can be predetermined in the main controller 11, generally 3-6 m, so as to avoid impacting barriers such as air conditions on the outer surface of the wall during lowering. Data about the height and the distance can be input into the main controller 11 via the buttons 1911 and 1912 respectively and stored therein. The initial height, for example 120 m, can be displayed on the indicator 1914; while the lowering-speed of the rope 42, for example 0 m/s in initial, can be displayed on the indicator 1913. After the lowering process of the rope 42 has begun, the numerical value displayed on the indicator 1914 which shows the height of the rope 42 will lessen, while the numerical value displayed on the indicator 1913 which shows the lowering-speed of the rope 42 will become large. The line indicator 1915 is intended to show whether the power is supplied, while the indicator light 1916 is intended to show whether the main controller 11 has received a signal from the remote control 20.

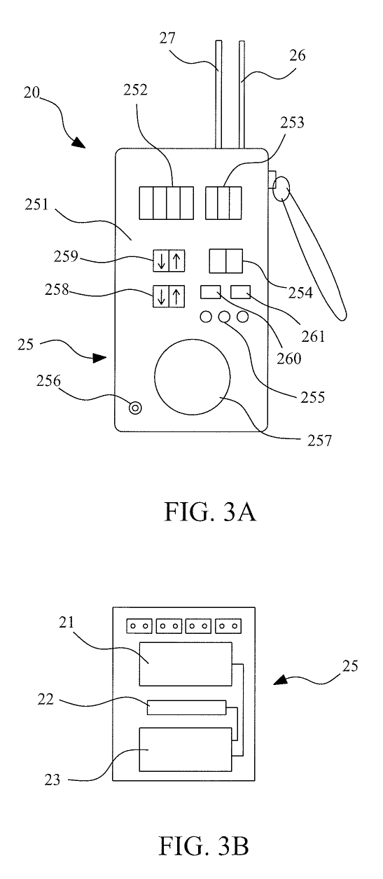

Referring to FIG. 3A and FIG. 3B, according to one embodiment of the present invention, the hand-held wireless remote control 20 comprises a casing 25 having a remote control panel 251; a Single-Chip Microcomputer 23 disposed within the casing 25; a wireless communication transceiver module 21 and a wireless talk-back module 22 disposed within the casing 25 and electrically communicated with the Single-Chip Microcomputer 23, respectively; a wireless transceiver antenna 26 disposed at the top of the casing 25 and electrically communicated with the wireless communication transceiver module 21; and a wireless talk-back antenna 27 disposed at the top of the casing 25 and electrically communicated with the wireless talk-back module 22. On the remote control panel 251 an indicator 252 of height, an indicator of speed 253, an indicator 254 showing a distance between an escapee and a wall, a line indicator 255, a microphone 256, a speaker 257, speed-adjusting buttons 258, an distance-adjusting buttons 259, a descend button 260 and a stopping button 261 are provided (see FIG. 3A). The line indicator 255 is electrically connected to a battery tray and the others are electrically communicated with the Single-Chip Microcomputer 23.

The remote control 20 can be supplied by a 6V high-energy storage battery. Furthermore, the wireless remote control 20 held by the escapee is provided with a laser altimeter 28 (see FIG. 1) electrically communicated with the wireless communication transceiver module 21. The laser altimeter 28 continuously measures the height between an escapee and the ground during a lowering process, and sends the data measured to the wireless communication transceiver module 21 which will send the data to the main controller 11 in which the data are compared with the data measured by the measurement mechanism 16. Finally, the main controller 11 transmits correct data on the distance to the indicator 252 which displays the height of real time.

Referring back to FIG. 1, the man-carrying unit 30 according to one embodiment of the present invention comprises a hanging beam 192 connected to one end of the rope 42; and an integral fireproof and anti-collision survival-suit 31 having a torso portion 311, leg portions 312 and arm portions 313 which are made of fireproofing and antiflaming materials known in the art. The survival-suit 31 is opened at the front thereof with a zipper 317, being provided with a loop-strap 315 for surrounding an escape's breast and at least two support straps 316 extending longitudinally to cross the crotch of the survival-suit 31 and connect the hanging beam 192. A pair of gloves 32 and a helmet 33, both made of fireproofing and antiflaming materials, are also provided.

The man-carrying unit 30 can effectively protect an escapee in fire. Usually, the man-carrying unit 30 can be disposed at a place near a life-flee window or a closet in a room for emergency, where a striking signpost should be set. Therefore when an emergency occurs, escapees can readily go there to find the man-carrying unit 30.

In order to help babies or children escape, a bag 34 configured to be of anti-collision and attached to the man-carrying unit 30 to receive the babies or children may be provided according to the present invention.

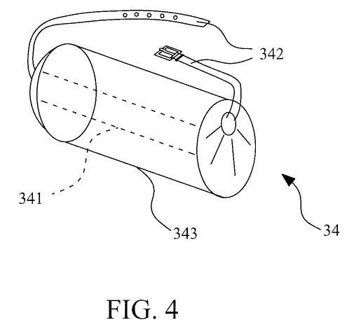

As shown in FIG. 4, according to one embodiment of the invention, the bag 34 comprises a metal frame 341 and a cloth 343 housing the frame 341. Furthermore, the bag 34 can be provided with straps 342 at both the ends thereof such that the bag 34 can be fixed to the survival-suit 31 by the straps 342.

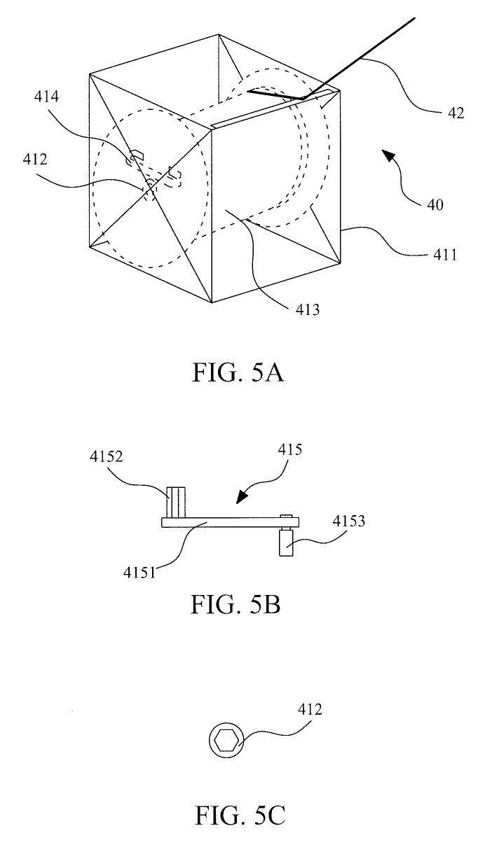

In a preferred embodiment, as shown in FIG. 5A through 5C, the rope winding unit 40 comprises a support frame 411 to be fixed onto a building; an axle 412 respectively mounted to two opposite sides of the support frame 411; and a roll 413 rotatably mounted onto the axle 412 for winding the rope 42. An elastic brake plate 414 disposed between the roll 413 and the frame 411 for braking the roll 413 in a damping manner, and a handle mechanism 415 which can be coupled to one end of the axle 412 for rolling the roll 413.

In an embodiment as shown in FIG. 5B, the handle mechanism 415 is configured to have an arm 4151, and a rod 4152 disposed at one end of the arm 4151 and configured to be inserted into a hollow axle 412 as shown in FIG. 5C. A handle 4153 is provided at the other end of the arm 4151 to operate the roll 413. As such, the rope 42 can be rolled back onto the roll 413 by the handle 4153 after operation of the escape device.

In order to avoid that escapees meet those attached to the building such as air conditions a positioning device 50 can be provided according to the present invention intended to control the orientation of the man-carrying unit 30 in air and the distance between an escapee and the wall during a lowering process.

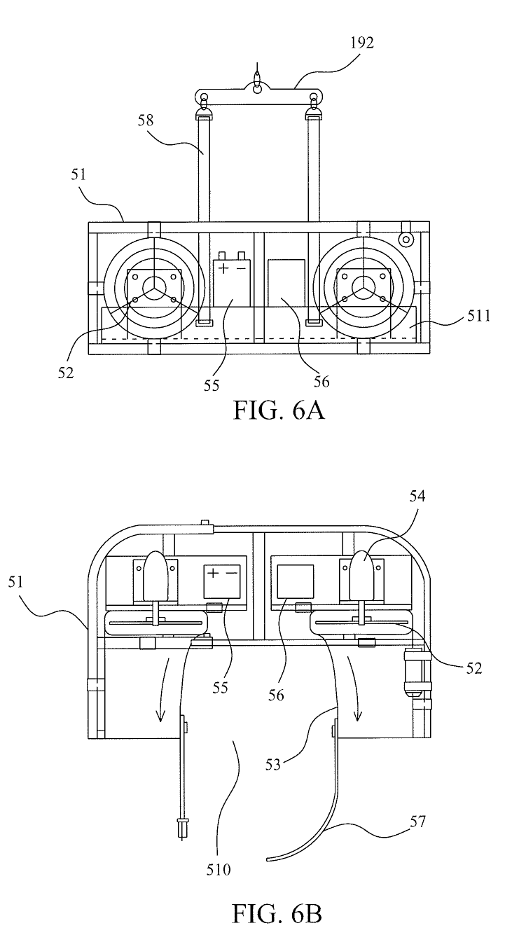

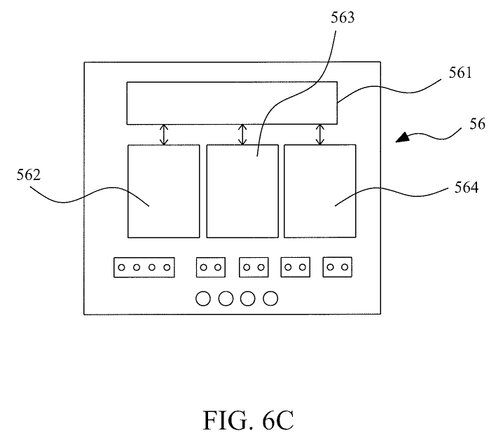

Referring to FIG. 6A and FIG. 6B, the positioning device 50 according to one embodiment of the invention comprises a security frame 51 in a substantial U-shape, having a plurality of rods connected to each other to provide a space 510 for receiving an escapee in the front thereof. Two clamping-straps 57 are provided to secure the escapee.

The security frame is connected to the rope 42 at the upper end thereof and provides a base 511 at the lower end thereof. Two motors 54 are symmetrically disposed onto the base 511 to drive two propellers 52. Two hollow cylinders 53 respectively connected to the propellers 52 are provided to guide air from the propeller 52 toward the wall. As such, the positioning device 50 can be controlled to move in the horizontal direction relative to the wall.

A shortage battery 55 is provided to supply power to the motor 54 and a controller 56 that controls the motor 54.

Referring to FIG. 6C, the controller 56 comprises a control module 561 that can be a Single-Chip Microcomputer; a distance sensing module 562, which can be a supersonic sensor, electrically connected to the control module 561; an orientation sensing module 563 that can be an electron compass sensor, electrically connected to the control module 561; and an wire communication module 564 electrically connected to the control module 561, for transmitting and receiving signals. All the modules used in the device 50 are commercially available.

The controller 56 receives data on a predetermined distance from an escapee to a wall from the hand-held wireless remote control 20 via the wire communication module 564. Afterwards the data will be sent to the control module 561 in which the data are calculated with the data of an escapee's orientation (for example an angle) in air from the orientation sensing module 563 and that of a real-time distance of the escapee to the wall from the distance sensing module 562. Then the control module 561 outputs a control signal to control rotating speeds of the motor 54 and the propeller 52 according to the outcome calculated, so as to control the orientation and distance of the escapee to the wall during the lowering process.

The device 50 is connected to the hanging beam 192 by two galluses 58 that are connected to the middle portion of the base 511.

Firstly, the positioning device 50 can determine the orientation of the escapee in air, and therefore the escapee can always face to the wall during the lowering process. Secondly, it can adjust the distance from the escapee to the wall.

As a result, not only can accidents such as impacting barriers on the wall be avoided, but also it is possible to choose a good landing spot, which ensures the escapee' safety during the lowering process.

A suspension mechanism can be provided for fixing the main control unit 10 according to the present invention.

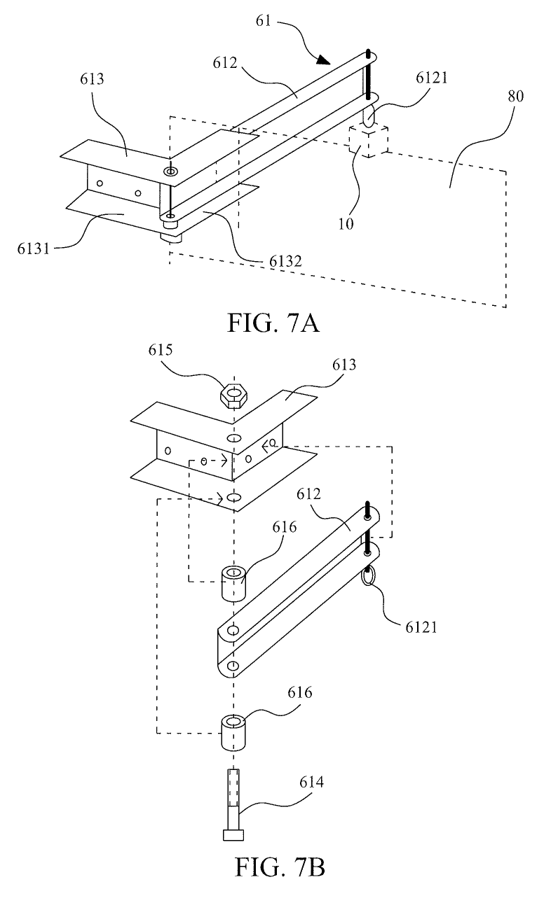

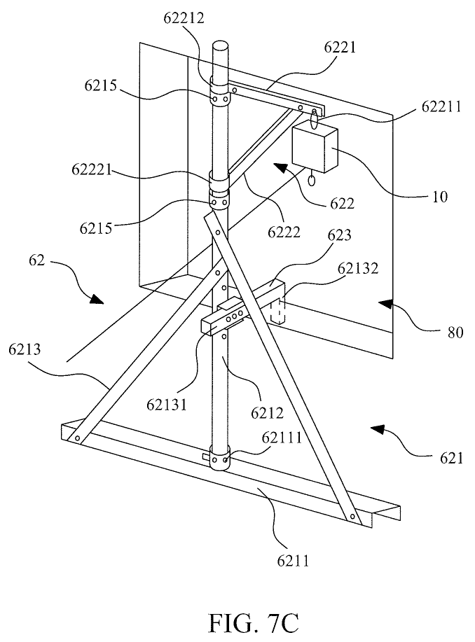

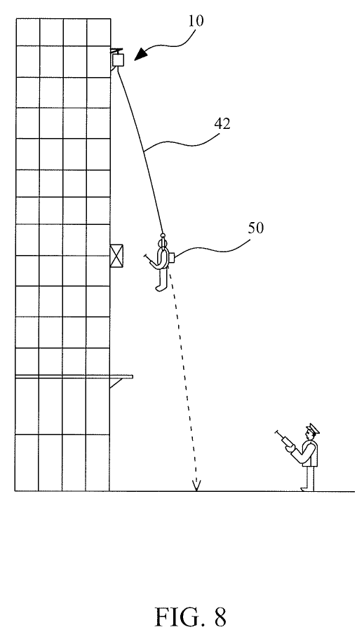

Referring to FIG. 7A and FIG. 7B, according to one embodiment of the invention, the suspension mechanism is a cantilever mechanism 61 which comprises: a fastening support 613 configured to have an L-channel bar shape and fixed to a corner of a wall, having a first portion 6131 and a second portion 6132 perpendicularly connected to the first portion 6131. Each of portions 6131, 6132 includes a top plate, a bottom plate and a side wall connecting the top wall to bottom wall.

The mechanism 61 also comprises a rotatable cantilever 612 of which one end is hinged onto the joint between the first portion 6131 and the second portion 6132 and the other end is provided with a suspension link 6121 for hanging the main control unit 10.

The cantilever 612 is configured to have a shape similar to the first portion 6131 and the second portion 6132, but smaller in size than them. And thus the cantilever 612 can be received within the first portion 6131 or the second portion 6132. As shown in FIG. 7B, the cantilever 612 is hinged onto the corner of the support 613 by a bolt 614, a nut 615 engaged with the bolt 614 and two plain bearing 616 disposed between the top and bottom plates of the cantilever 612 and the support 613 respectively. The cantilever 612 can then rotate in a horizontal plane around the bolt 614 to be received within the first portion 6131 or the second portion 6132 respectively.

Typically, the cantilever mechanism 61 is fixed to a window 80 of the building, as shown in FIG. 7A. Normally the main control unit 10 is hanged onto the suspension link 6121 and the cantilever 612 rotates to a position inside the building (for example received within the first portion 6131). When an emergency occurs, the escapee can push the cantilever 612 to a position outside the building (for example received within the second portion 6132). At this position, the rope 42 can be easily controlled by the main control unit 10.

The suspension mechanism according to another embodiment of the present invention is a bracket unit that can be disposed onto a window of the building.

Referring to FIG. 7C, the bracket unit 62 comprises a bracket 621 including a bottom lever 6211 disposed horizontally, a center rod 6212 disposed longitudinally and fixed to the center of the bottom lever 6211, and two inclined rods 6213 respectively connected to the two ends of the bottom lever 6211 and the rod 6212.

In this embodiment, a suspender 622 is provided to hang the main control unit 10, which includes a horizontal girder 6221 and an inclined girder 6222 both of which are rotatably fixed onto, with one end thereof, the longitudinal rod 6212 by two sleeves 62212, 62221 respectively, while the other end of the inclined girder 6222 is connected to a portion of the horizontal girder 6221 close to the other end thereof. A ring or a hole 62211 is provided at the other end of the longitudinal rod 6212 to connect the main control unit 10.

A fixed rod 623 in an L shape provides an arm 62131 fixed to the longitudinal rod 6212 and another arm 62132 perpendicular to the arm 62131 to be fixed to a wall or a window of the building.

As shown in FIG. 7C, the bottom lever 6211, the longitudinal rod 6212 and the two inclined rods 6213 constitute the bracket unit 62. The fixed rod 623 prevents the bracket 62 from turning over to the inside of the building. The longitudinal rod 6212 is extended over the upper edge of the window 80, which ensures the bracket unit 62 not to turn over to the outside of the building.

In a preferred embodiment, a low end of the longitudinal rod 6212 is inserted into a sleeve 62111 disposed at the center of the bottom lever 6211. Two collars 6215 housing the longitudinal rod 6212 are positioned under the two sleeves 62221, 62212, respectively, so as to support them.

Now the operation of the apparatus according to the present invention is described as below.

At ordinary times, the main control unit 10, one or more remote controls 20 and the positioning device 50 are charged on a charging device (not shown). The main control unit 10 is hanged on, for example the cantilever 612, while the rope winding unit 40 is fixed to a wall of a building or just put on a floor. One end of the rope 42 is connected to the hanging beam 192 through the main control unit 10. The height of the current floor from the ground, for example 123 m, and the initial speed 0 m/s are shown on the panel 191 of the housing 19 and on one of the remote controls 20.

When a fire occurs, an escapee should take one or more remote controls 20, put on the fireproof and anti-collision survival-suit 31, and connect the support strap 316 to the hanging beam 192. The escapee should enter the positioning device 50 if he is in a high story and has to use the positioning device 50.

Then the escapee or the escort presses the stopping button 261 and the escapee tries to move. If he cannot move, it means that the device is operable. Afterwards, the escapee or the escort can rotate the rotatable cantilever 612 towards the outside of a window; then the escapee goes out from the window and presses the descend button 260 disposed on the remote control 20. Thus the escapee begins to lower and the main control unit 10 and the positioning device 50 begins to work.

From that moment, the escapee, the escort or the receiving persons on the ground can control the lowering process by the remote control 20 held on their hands, respectively, on which all the data including the lowering speed and height, and a distance from the escapee to the wall are displayed. If there are no barriers on the wall, they can press the “acceleration” button to reach the ground quickly. However, if there are barriers on the wall, they should press the “deceleration” or “stop” button to decrease the lowering speed or make the escapee stop for the escapee's safety. Moreover, the distance-adjusting buttons 259 can be pressed to increase the distance between the escapee and the wall to avoid impacting the barriers.

When the escapee descends to 25m from the ground, the remote will sound to remind the escapee and control the main control unit 10 to begin to decrease the lowering speed automatically. When the escapee descends to approximate 3 m from the ground, the lowering speed will be about 0.5 m/s. Then the escapee lands on the ground softly and slowly. A track of lowering the escapee is shown in FIG. 10. When the escapee lands on the ground, the beam 192 should be disconnected to the support strap 316 at once. Afterwards, the receiving person on the ground should help the escapee move to a safe place and take off the man-carrying unit 30 there.

The preferred embodiments described above are only to illustrate the present invention and should not be construed any limitations to the present invention. It is understood that various modifications and alterations to the embodiments of the invention without departing from the spirit of the present invention can be made for those skilled in the art.

1. A fire escape device that can be controlled wirelessly, comprising:
a rope winding unit comprising a connecting means;
a carrying unit attached to one end of the connecting means;
a main control unit fixed onto a building,
said connecting means being connected to the carrying unit and the main control unit in such a manner that the movement of the carrying unit can be controlled by said main control unit and said connecting means; and
a wireless remote control capable of communicating with the main control unit and operating the same.

2. The fire escape device of claim 1, wherein the main control unit comprises:
a housing;
a main controller configured to communicate with the remote control, wherein said main controller is placed inside the housing and is electrically connected to a main control panel; and
a cartridge placed inside the housing;
a pulley placed inside said cartridge, said pulley being connected to the connecting means.

3. The fire escape device of claim 2 comprising a first shaft, a second shaft, a speed-limiting mechanism and a brake unit, said first shaft, second shaft, speed-limiting mechanism and a brake unit being placed axially in sequence within the cartridge, said first shaft being connected to a pulley, said second shaft being connected with a measurement mechanism configured to measure a lowering-distance, and said first shaft and said second shaft being connected by a speed-increasing gear train.

4. The fire escape device of claim 2, wherein a plurality of guide pulleys for guiding the connecting means are disposed within the cartridge and beneath the pulley, and wherein grooves are formed along the periphery of the pulley and the periphery of the guide pulley.

5. The fire escape device of claim 3, wherein the speed-increasing gear train comprises a first gear group and a second gear group;
said first gear group comprising a first big gear and a first small gear, said first small gear being engaged to the first big gear;
said second gear group comprising a second big gear and a second small gear, said second small gear being engaged to the second big gear;
wherein the first big gear is mounted onto the first shaft and the first small gear is mounted onto a third shaft disposed on a vertical connecting-plate, wherein the second big gear is disposed onto the third shaft, said second big gear being coaxial with the first small gear, wherein the second small gear is mounted onto the second shaft.

6. The fire escape device of claim 3, wherein the measurement mechanism comprises:
an electromagnetic impulse plate made of materials having high magnetic conductivity, wherein said electromagnetic impulse plate has a plurality of teeth on its periphery, and is mounted onto the second shaft wherein said electromagnetic impulse plate and said second shaft are capable of rotating synchronously, and
an electromagnetic sensor disposed on the cartridge or on the housing, said electromagnetic sensor having an iron core, said iron core having a front end that is adjacent to the electromagnetic impulse plate.

7. The fire escape device of claim 3, wherein the speed-limiting mechanism comprises:
a centrifugal speed-limiting plate being of a disc-like shape, said centrifugal speed-limiting plate having a plurality of recesses at its periphery with intervals separating the recesses, said centrifugal speed-limiting plate being mounted onto the second shaft and being capable of rotating synchronously with the second shaft; and
a plurality of centrifugal blocks slidably disposed within the recesses, wherein each recess is fit with one centrifugal block, said centrifugal blocks being elastically connected to the centrifugal speed-limiting plate, wherein a gap exist between the inner surface of the cartridge and the outer surface of the centrifugal blocks,
said centrifugal blocks being capable of rotating synchronously with the centrifugal speed-limiting plate, wherein such a rotation by the centrifugal blocks is capable of overcoming an elastic force and causes the centrifugal blocks to press the inner surface of the cartridge when rotating speed of the centrifugal blocks reaches a predetermined value, thereby generating a friction force for decelerating the centrifugal blocks.

8. The fire escape device of claim 3, wherein the brake unit comprises a magnetic powder brake, said magnetic powder brake comprising:
a stator comprising a casing disposed within the cartridge and a coil disposed within the casing, said coil being electrically connected to the main controller; and
a rotator disposed within the casing, said rotator being mounted onto a hollow shaft connected to the second shaft via a coupling.

9. The fire escape device of claim 3, wherein the brake unit comprises a manual brake for decelerating and stopping the movement of the connecting means in case of emergency.

10. The fire escape device of claim 9, wherein the manual brake comprises:
a braking plate being mounted onto the second shaft and capable of rotating with the second shaft;
a braking clamp comprising at least two clamp levers which are hinged together at about the center thereof, said at least two clamp levers being divided into two portions by a hinging pivot, wherein the first portion surrounds the braking plate and forms a pair of braking arms, with the second portion extending downwards forming a pair of handles wherein a compression spring is disposed between the two portions;
a brake rope connected to the free end of the pair of the handles; and
a braking gripe connected to the brake rope wherein the braking gripe causes the braking arms to press on the braking plate.

11. The fire escape device of claim 10, wherein at least one brake shoe for contacting the braking plate is mounted onto the inside of the clamp levers by at least one adjustable screw.

12. The fire escape device of claim 1, wherein the wireless remote control comprises:
a casing having a remote control panel;
a Single-Chip Microcomputer disposed within the casing;
a wireless communication transceiver module disposed within the casing and being connected to the Single-Chip Microcomputer;
a wireless talk-back module disposed within the casing and electrically connected to the Single-Chip Microcomputer;
a wireless transceiver antenna disposed at the top of the casing and being connected to the wireless communication module;
a wireless talk-back antenna disposed at the top of the casing and being connected to the wireless talk-back module;
at least one indicator being selected from the group consisting of an indicator of height, an indicator of speed, an indicator of distance between an escapee and a wall, and a line indicator, said line indicator is electrically connected to a battery tray;
a microphone;
a speaker; and
at least one control button being selected from the group consisting of a speed-adjusting button, a distance-adjusting button, a descend button and a stopping button.
wherein said at least one control button is electrically connected to the Single-Chip Microcomputer.

13. The fire escape device of claim 12, wherein the wireless remote control further comprises a laser altimeter electrically connected to the wireless communication transceiver module.

14. The fire escape device of claim 1, wherein the carrying unit comprises:
a hanging beam attached to one end of the connecting means;
a fireproof and anti-collision integral survival-suit having a torso portion, leg portions and arm portions which are made of fireproofing and antiflaming materials, the survival-suit being opened on the front thereof and closable by a zipper, being provided with a loop-strap for surrounding an escapee's breast, and at least two support straps extending longitudinally to cross the crotch of the survival-suit and connect to the hanging beam;
a pair of gloves made of fireproofing and antiflaming materials;
a helmet made of fireproofing and antiflaming materials; and
a bag being of anti-collision comprising a metal frame and a cloth housing the frame, the bag being provided with a strap at both the ends.

15. The fire escape device of claim 1, wherein the rope-winding unit further comprises:
a support frame fixed onto a building;
an axle mounted to the frame;
a roll for winding the connecting means, said connecting means being rotatably mounted onto the axle;
an elastic brake plate disposed between the roll and the frame for making the roll in a damping manner; and
a rolling mechanism coupled to one end of the axle capable of performing the rolling function.

16. The fire escape device of claim 3, further comprising a positioning device for controlling the orientation of the carrying unit and the distance between the carrying unite and a wall during the descent, which comprises:
a frame comprising a plurality of rods, wherein said rods are substantially U-shaped and are connected to each other to provide a space for receiving an escapee in the front thereof and two clamping-straps to secure the escapee;
at least one motor disposed onto the base;
at least one propeller driven by the motor, so as to make the positioning device move in the horizontal direction relative to the wall;
at least one hollow cylinder for guiding air from the propeller towards the wall;
a shortage battery for supplying power to the motor; and
a controller that controls the motor.

17. The fire escape device of claim 16, wherein the controller comprises:
a control module being a Single-Chip Microcomputer;
a distance-sensing module being a supersonic sensor and electrically connected to the control module;
an orientation-sensing module being electron compass sensor, said orientation-sensing module being electrically connected to the control module; and
an wire communication module capable of transmitting and receiving signals, said wire communication module being electrically connected to the control module.

18. The fire escape device of claim 3, further comprising a cantilever mechanism to fix the main control unit, said cantilever mechanism comprising:
a fastening support fixed to a corner of a wall, said fastening support comprising a first portion and a second portion, said second portion being perpendicularly connected to the first portion, wherein each of the portions includes a top wall, a bottom wall and a side wall, said side wall connecting the top wall and the bottom wall; and
a rotatable cantilever having two ends, wherein one end of said cantilever is hinged onto the joint between the first portion and the second portion and the other end of said cantilever is provided with a suspension line for hanging the main control unit.

19. The fire escape device of claim 3, further comprising a cantilever mechanism to fix the main control unit, said cantilever mechanism comprising a bracket unit disposed onto a window, the bracket unit comprising:
a bracket including a bottom lever disposed horizontally;
a center rod disposed longitudinally and fixed to the center of the bottom lever; and
at least two inclined rods connected to the bottom lever and the rod respectively;
a suspender to hang the main control unit, which includes a horizontal girder and an inclined girder both of which are rotatably fixed onto, with one end thereof, the center rod by two sleeves respectively, while the other end of the inclined girder is connected to a portion of the horizontal girder close to the other end thereof, and a ring or a hole being provided at the other end of the center rod; and
a fixed rod in an L-shape, having a first arm fixed to the center rod and a second arm being perpendicular to the first arm.
